(19) United States
(12) Patent Application Publication
(10) Pub. No.: US 2014/0196701 A1
(43) Pub. Date: Jul. 17, 2014

(54) METHOD FOR OPERATING AN EXHAUST GAS RECIRCULATION SYSTEM

(71) Applicant: GM Global Technology Operations LLC, Detroit, MI (US)

(72) Inventors: Boris STOJKOVIC, Warren, MI (US); Domenico RAMPONE, Asti (IT); Paolo PAGANO, Torino (IT); Paolo PASERO, Torino (IT)

(73) Assignee: GM Global Technology Operations LLC, Detroit, MI (US)

(21) Appl. No.: 14/153,672

(22) Filed: Jan. 13, 2014

(30) Foreign Application Priority Data
Jan. 11, 2013 (GB) 1300481.7

(51) Int. Cl. F02M 25/07

(52) U.S. Cl. CPC F02M 25/0754
USPC 123/568.12

(57) ABSTRACT

A method is provided for operating an Exhaust Gas Recirculation (EGR) system of a thermal energy source, the EGR system includes, but is not limited to an EGR circuit and an EGR cooler, the EGR cooler connected in a heat exchanging relationship with an EGR coolant circuit equipped with an EGR coolant pump. The method includes, but is not limited to monitoring a parameter (T_{EGRcool}) representative of a temperature of the coolant in the EGR coolant circuit, operating the EGR coolant pump on the basis of the parameter (T_{EGRcool}) and of a target value thereof (T_{EGRtgt}).

### CROSS REFERENCE TO RELATED APPLICATION

This application claims priority to GB Patent Application No. 1300481.7, filed Jan. 11, 2013, which is incorporated herein by its entirety.

### TECHNICAL FIELD

The technical field relates to a method for operating an Exhaust Gas Recirculation (EGR) system.

### BACKGROUND

An internal combustion engine for a motor vehicle generally comprises an engine block that defines at least one cylinder accommodating a reciprocating piston coupled to rotate a crankshaft. The cylinder is closed by a cylinder head that cooperates with the reciprocating piston to define a combustion chamber. A fuel and air mixture is cyclically disposed in the combustion chamber and ignited, thereby generating hot expanding exhaust gasses that cause the reciprocating movements of the piston. The fuel is injected into each cylinder by a respective fuel injector. The fuel is provided at high pressure to each fuel injector from a fuel rail in fluid communication with a high pressure fuel pump that increases the pressure of the fuel received from a fuel source.

Internal combustion engines comprise a cooling system for thermal management. The engine cooling system comprises hydraulically interconnected conducts, which are comprised in the engine crankcase, engine cylinder block and engine cylinder head, to thereby defining an engine coolant circuit. The engine coolant circuit is hydraulically connected to a coolant pump for circulating a coolant, such that the heat generated by engine components during normal operation is transferred by conduction and/or convection to the coolant. The engine coolant circuit is further hydraulically connected to a radiator for removing heat from the coolant. The coolant can be distilled water or preferably a mixture of water, antifreeze and other additives, which are suitable for increasing the cooling efficiency.

Some internal combustion engines, typically but not exclusively Diesel engines, comprise an exhaust gas recirculation (EGR) system, by means of which part of exhaust gas exiting the engine exhaust manifold is channeled back into the engine intake manifold, particularly for reducing NOx emission. For achieving this result, the exhaust gas must be cooled before entering the engine intake manifold. The exhaust gas is conventionally cooled with one or more EGR coolers. A so-called EGR cooler is constructed as a heat exchanger which is in hydraulic communication with the exhaust manifold and the intake manifold, such that the heat of exhaust gas is transferred by conduction and/or convection to a coolant which circulates in the heat exchanger.

In some realizations, the EGR cooler is comprised in the engine cooling system, in order to use a single radiator for both the engine coolant circuit and the EGR cooler, without any increased cost on the vehicle. In several realizations, the EGR cooler is comprised in an auxiliary cooling system, which is fully separated by the engine cooling system, and thereby comprises auxiliary radiator and auxiliary coolant pump.

Some other realizations provide for an auxiliary coolant circuit and an auxiliary coolant pump located in an auxiliary coolant circuit for moving the coolant in the auxiliary circuit. The auxiliary coolant circuit is further hydraulically connected to the engine coolant circuit radiator for removing heat from the coolant. A realization of the latter kind provides the cooling system which is described hereinafter.

A problem that may arise in the use of high efficiency EGR systems is that exhaust gas condensation may occur. More specifically, exposure to low exhaust gas temperatures that occurs at low thermal load conditions and/or during interrupted running profiles, prevents the thermal system to reach temperatures sufficiently high to avoid condensation in the EGR system components. This problem is particularly relevant since during normal driving conditions the driver profile is not known a priori. Gas condensation may lead to EGR cooler clogging, causing a negative impact on engine performance.

At least one object of an embodiment is to provide an active control of the temperature of the coolant of the EGR cooler, since this temperature heavily influences the possibility of exhaust gas condensation. At least another object of an embodiment is to provide a strategy of controlling the EGR coolant temperature at high thermal load conditions of the engine, in order to maintain the temperature sufficiently high to avoid exhaust gas condensation, while at the same time avoiding EGR coolant boiling. At least a further object of an embodiment is to provide a heating strategy for heating the EGR coolant in the proximity of the EGR cooler and use this warmed-up coolant during EGR cooler mode. At least a further object of an embodiment is to provide a specific EGR coolant temperature control strategy to be used during the warm up phase of the engine. At least another object of an embodiment is to avoid high HydroCarbon (HC) levels through EGR cooler radiator at low exhaust temperatures and flows. Furthermore, other objects, desirable features and characteristics will become apparent from the subsequent summary and detailed description, and the appended claims, taken in conjunction with the accompanying drawings and this background.

### SUMMARY

These objects are achieved by a method, by an engine, by an apparatus, by an automotive system, by a computer program and by a computer program product. The dependent claims delineate preferred and/or especially advantageous aspects.

An embodiment provides a method of operating an Exhaust Gas Recirculation (EGR) system of a thermal energy source, the EGR system comprising an EGR circuit and an EGR cooler, the EGR cooler connected in an heat exchanging relationship with an EGR coolant circuit equipped with an EGR coolant pump, the method comprising monitoring a parameter representative of a temperature of the coolant in the EGR coolant circuit; operating the EGR coolant pump on the basis of the parameter and of a target value thereof. At least one advantage of this embodiment is that the EGR coolant pump is not only used to provide additional cooling capacity to reduce the temperature of the recirculated exhaust gas, but also to provide an improved control of the EGR coolant temperature by cycling ON and OFF the pump.

According to a further embodiment, the method comprises activating for a predetermined activation time the EGR coolant pump if the monitored value of the parameter is higher than the target value; deactivating for a predetermined deactivation time the EGR coolant pump. At least one advantage of this embodiment is that it allows control of the activation/deactivation state of the EGR coolant pump with a simple strategy that does not imply a heavy computational effort by an Electronic Control Unit (ECU) of the system.

According to a further embodiment, the activation state of the EGR coolant pump is adjusted by means of a closed-loop control strategy that uses as feedback the parameter value to minimize a difference between the parameter value and the target value. At least one advantage of this embodiment is that it allows a refined control of the temperature of the EGR coolant.

According to another embodiment, the method comprises the further steps of: monitoring a parameter representative of a thermal load of the thermal energy source, and bypassing the EGR cooler if the parameter is lower than a first target value thereof representative of low thermal load conditions. At least one advantage of this embodiment is that it allows to heat up the EGR coolant at low thermal load conditions.

According to still another embodiment, the method comprises the further steps of: repeating the activation and deactivation steps of the EGR coolant pump if the parameter representative of a thermal load of the thermal energy source is higher than the first target value thereof and lower than a second target value thereof representative of the end of a warm up phase of the thermal energy source. At least one advantage of this embodiment is that it allows control of the EGR coolant temperature in an important phase of the driving profile considering that the driving profile is not known a priori.

According to a further embodiment, the thermal energy source is an internal combustion engine. An advantage of this embodiment is that the method can be applied in a wide variety of automotive systems.

According to a further embodiment of the method, the predetermined values of the activation time and of the deactivation time of the EGR coolant pump are determined by means of an empirically determined map correlating different values of the activation time and of the deactivation time to different values of engine speed, engine load, engine temperature, EGR gas flow in the EGR circuit, environmental temperature and pressure. At least one advantage of this embodiment is that it allows memorization of the pattern of activation and deactivation of the EGR coolant pump to be used during different driving profiles.

According to a further embodiment of the method, the parameter indicative of a thermal load of the engine is a function of engine temperature, engine speed and engine torque. At least one advantage of this embodiment is that it allows identification and takes into account the main variables that affect the thermal load of the engine and use these variables to control the bypassing of the EGR cooler.

An Exhaust Gas Recirculation (EGR) system of a thermal energy source is provided for use in the method according to the above embodiments, the EGR system comprising an EGR circuit and an EGR cooler, the EGR cooler being connected in a heat exchanging relationship with an EGR coolant circuit equipped with an EGR coolant pump. The EGR circuit and the EGR cooler have portions that are adjacent to each other to form a heat exchange area for the exhaust gas. At least one advantage of this embodiment is that the presence of the heat exchange area is allowed to heat up the EGR coolant during warm up of the engine.

An apparatus is provided for operating an Exhaust Gas Recirculation (EGR) system of an internal combustion engine, the EGR system comprising an EGR circuit and an EGR cooler, the EGR cooler connected in an heat exchanging relationship with an EGR coolant circuit equipped with an EGR coolant pump, the apparatus comprising: a monitor for monitoring a parameter representative of a temperature of the coolant in the EGR coolant circuit; an operating device for operating the EGR coolant pump on the basis of the parameter and of a target value thereof

According to another embodiment, the monitor comprises a coolant temperature sensor. At least one advantage of this embodiment is that it provides a reliable system for monitoring the EGR coolant temperature.

An automotive system is provided comprising an internal combustion engine, managed by an engine Electronic Control Unit, the engine being equipped with an EGR system comprising an EGR circuit and an EGR cooler, the EGR cooler being connected in an heat exchanging relationship with an EGR coolant circuit equipped with an EGR coolant pump, the Electronic Control Unit being configured to: monitor a parameter representative of a temperature of the coolant in the EGR coolant circuit; and operate the EGR coolant pump on the basis of the parameter and of a target value thereof Also this embodiment has at least the same advantages of the method disclosed above.

The method can be carried out with a computer program comprising a program-code for carrying out all the steps of the method described above, and in the form of computer program product comprising the computer program. The computer program product can be embodied as a control apparatus for an internal combustion engine, comprising an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out. A still further embodiment provides an internal combustion engine specially arranged for carrying out the method claimed.

### BRIEF DESCRIPTION OF THE DRAWINGS

The present invention will hereinafter be described in conjunction with the following drawing figures, wherein like numerals denote like elements, and:

FIG. 1 is an automotive system;

FIG. 2 is a cross-section of an internal combustion engine belonging to the automotive system of FIG. 1;

FIG. 3 is a diagram that represents an Exhaust Gas Recirculation system according to an embodiment;

FIG. 4 is a graph depicting several parameters of the EGR system during the application of an embodiment of the method to an exemplary engine running profile;

FIG. 5 is a flowchart representing an embodiment of the method; and

FIG. 6 is a flowchart representing another of the method.

### DETAILED DESCRIPTION

The following detailed description is merely exemplary in nature and is not intended to limit application and uses. Furthermore, there is no intention to be bound by any theory presented in the preceding background or the following detailed description.

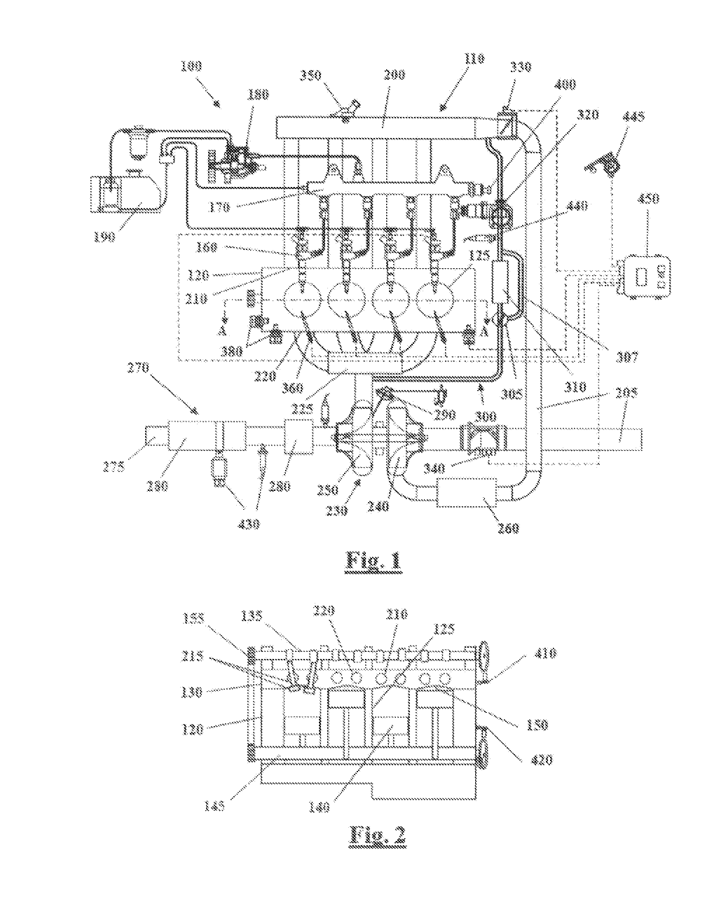

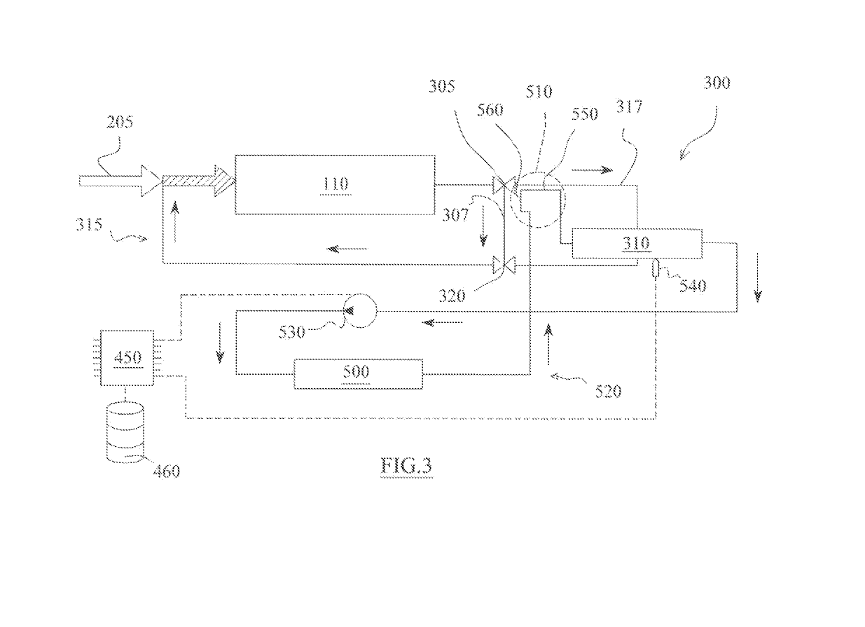

Some embodiments may include an automotive system 100, as shown in FIG. 1 and FIG. 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust after treatment devices 280. The after treatment devices may be any device configured to change the composition of the exhaust gases. Some examples of after treatment devices 280 include, but are not limited to, catalytic converters (two and three way), oxidation catalysts, lean NOₓ traps 285, hydrocarbon absorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300. The EGR system 300 may also include an EGR bypass 307 and an EGR bypass valve 305, the EGR bypass valve 305 being operable in order to bypass the EGR cooler 310.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier 460, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

More specifically, an Exhaust Gas Recirculation system 300 according to an embodiment of the invention is represented in FIG. 3. The EGR system 300 is connected to the combustion engine 110, but the various embodiments of the method of the invention described therein may also be applied to thermal energy sources in general, such as furnaces, oil refining plants, marine engines or in general to all EGR applications which may need an active control of EGR coolant temperature.

The EGR system 300 comprises an EGR circuit 315 equipped with the EGR cooler 310. The EGR valve 320 regulates the flow of exhaust gases in the EGR system 300. The EGR system 300 may also include an EGR bypass 307 and an EGR bypass valve 305, the EGR bypass valve 305 being operable in order to bypass the EGR cooler 310. The EGR cooler 310 is also connected in a heat exchanging relationship with an EGR coolant circuit 520 equipped with an EGR coolant pump 530. Preferably the EGR coolant circuit 520 is an auxiliary coolant circuit within the main coolant circuit of the engine 110 and the EGR coolant pump 530 is an auxiliary coolant pump in addition to the main coolant pump (not represented for simplicity) of the main cooling circuit of the engine 110. The EGR coolant circuit 520 is further hydraulically connected to the engine coolant circuit radiator 500 for removing heat from the coolant.

According to a preferred embodiment, the EGR circuit 315 and the EGR coolant circuit 520 may have circuit portions 550,560 which are adjacent to each other to form a heat exchange area 510 for the exhaust gas. A first EGR coolant circuit portion 550 is close to a branch 317 of the EGR circuit 315 leading to the EGR cooler 310 from the EGR bypass valve 305. A second EGR coolant circuit portion 560 is close to the EGR bypass 307.

The EGR coolant pump 530 is connected to the electronic control unit (ECU) 450 of the engine 110, the ECU 450 being associated to a memory unit or data carrier 460 to store a computer program to operate the EGR coolant pump 530 according to the various embodiments of the method described herein. An EGR coolant temperature sensor 540 suitable to monitor the EGR coolant temperature T_{EGRcool} can be placed in the EGR coolant circuit and be connected to the ECU 450 to send therein temperature data.

The EGR coolant temperature sensor 540 can be located in the EGR cooler 310 (as represented for example in FIG. 3), or alternatively at the inlet, or in a third alternative, at the outlet pipe of the EGR coolant circuit 520. In a preferred embodiment, the EGR coolant temperature T_{EGRcool} is controlled using the EGR coolant pump 530 in such a way that said temperature is kept around a target value thereof T_{EGRtgt}. The EGR coolant temperature target value T_{EGRtgt} is determined in order to minimize EGR cooler 310 exposure to conditions that lead to fouling or, generally speaking, to the accumulation of unwanted material on the solid surfaces of the EGR cooler to the detriment of its functions and to maximize the level of EGR cooling, which is one of the key factor in reducing engine emissions. To achieve this result and, more in particular, the desired temperature value T_{EGRtgt}, the EGR coolant pump is cyclically commanded ON for a time period t_{ON} and OFF for a time period t_{OFF}.

When the temperature of the coolant T_{EGRcool} in the EGR coolant circuit 520 is higher than the target temperature T_{EGRtgt}, the EGR coolant pump 530 is activated for the period of time t_{ON} in order to reduce the temperature rapidly. The time periods t_{ON} and t_{OFF} may be predetermined experimentally by calibration as a function of engine speed and load conditions, EGR gas flow, engine temperature, environmental temperature and pressure.

Furthermore, in order to heat the EGR coolant at low exhaust gas temperatures and flows and to avoid high Hydrocarbon (HC) levels through EGR radiator, an embodiment of the invention provides for exposing the EGR coolant to high exhaust gas temperatures present in the EGR bypass 307. The EGR bypass valve 305 is therefore opened at low thermal load conditions in order to activate the EGR bypass 307.

Furthermore, since portions 550,560 of the EGR coolant circuit layout is designed to form a heat exchange area 510 with the hot exhaust gas, the above effect is improved. Therefore, the ECU 450 may monitor a parameter TH_{Load} representative of a thermal load of the engine 110 and command the EGR valve 305 to bypass the EGR cooler 310 when the parameter TH_{Load} is lower than a predefined threshold TH_{Cutoff}. The predefined threshold TH_{Cutoff} indicates a value of thermal load at which the EGR bypass 307 is cutoff and the exhaust gases are made to flow through the EGR cooler 310. The EGR bypass 307 is maintained active therefore only at low thermal load conditions defined by parameter TH_{Load} being lower than the predefined threshold TH_{Cutoff}. The parameter TH_{Load} may be a function of the engine's conditions, such as engine temperature, engine speed, engine torque and other parameters related to the thermal output of the engine 110.

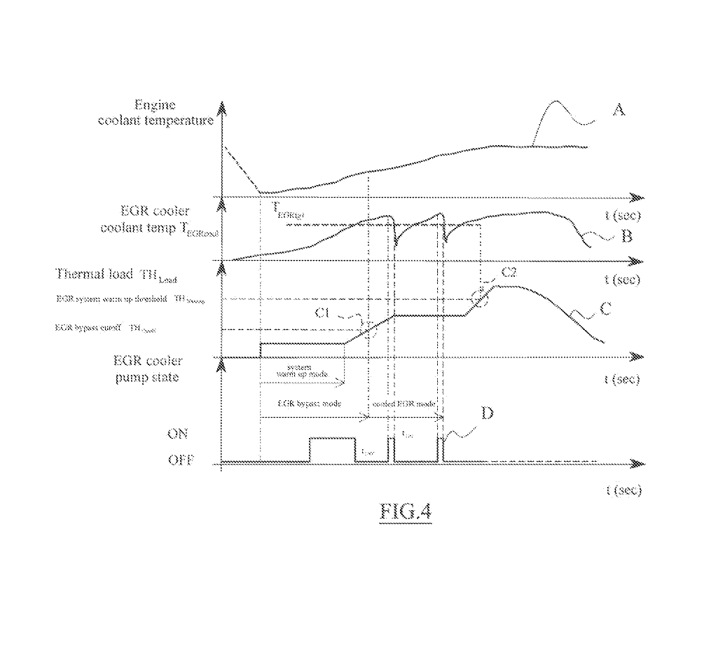

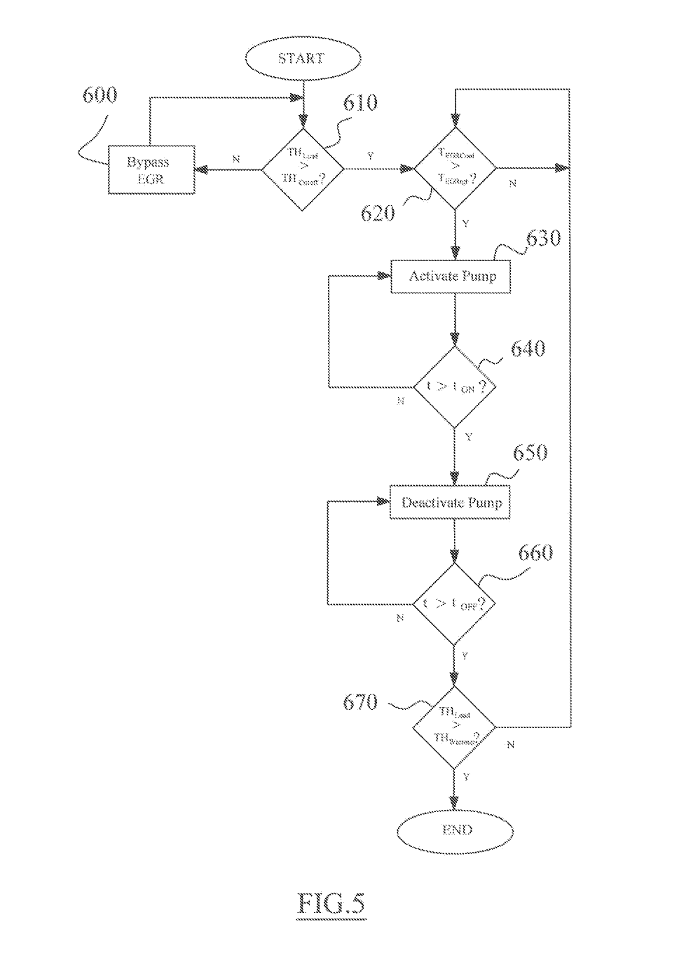

FIG. 4 is a graph depicting several parameters of the EGR system during the application of an embodiment of the method of the invention to an exemplary engine running profile. Generally speaking the most critical driving profile scenario is verified when the transitions in and out of the low and high thermal load conditions during the warm-up time of a thermal system are difficult to predict. The EGR coolant pump 530 is deactivated for time periods t_{OFF} to reduce boiling risk of the coolant fluid and to reach coolant temperatures sufficiently high to avoid condensation of the exhaust gas.

As shown in FIG. 4, after a certain time spent at low thermal load conditions, the system experiences a transient maneuver, reaching thermal load conditions at which the EGR coolant temperature T_{EGRcool} needs to be actively controlled, using the strategy described according the various embodiments. More specifically, curve C in FIG. 4 represents an exemplary engine driving profile.

Engine 110 is initially operated through a warm up phase in which it is subjected to a low thermal load TH_{Load}. During this initial warm up phase the engine coolant temperature T_{Engcool} (curve A) rises. The same applies to the EGR coolant temperature T_{EGRcool} (curve B). In general engine coolant temperature T_{Engcool} and EGR coolant temperature T_{EGRcool} may have different values. In order to achieve a quicker warm up of the engine 110, the EGR cooler 310 is initially bypassed, as indicated by the EGR bypass mode arrow of FIG. 4.

As indicated in the flowchart of FIG. 5, a check (block 610) can be made to verify if parameter TH_{Load} representing the instantaneous thermal load of the engine is higher that a predefined threshold TH_{Cutoff}. Until this condition is not verified, the EGR cooler 310 is bypassed (block 600). When this condition is verified, then the EGR bypass may be cut off (point C1 of curve C) and a new phase of cooling the EGR may be initiated. In this phase the EGR cooler pump 530 may be activated and deactivated as exemplified by curve D of FIG. 4 that represents the ON/OFF states of the EGR cooler pump 530. In this phase a check is made to verify if the EGR coolant temperature T_{EGRcool} is higher than the target value T_{EGRtgt} thereof (block 620). When this condition is verified, EGR coolant pump 530 is activated (block 630) and the EGR coolant temperature T_{EGRcool} drops rapidly in order to prevent the possibility of EGR coolant boiling.

EGR coolant pump 530 is then deactivated before EGR coolant temperature T_{EGRcool} drops too much in order to avoid EGR clogging. In particular, as mentioned above, the EGR coolant pump 530 may be maintained ON for a predefined time interval t_{ON} (block 640); when this time expires the EGR pump 530 may be deactivated (block 650). At this point the EGR pump may be maintained OFF for a predefined time interval t_{OFF} (block 660), when time t_{OFF} expires, the EGR coolant pump 530 may be deactivated (block 650).

This cycle may be repeated several times in order to keep EGR coolant temperature T_{EGRcool} at values not too distant from the target value T_{EGRtgt}. A final check (block 670) may be made to verify if the parameter TH_{Load} representing the instantaneous thermal load of the engine is higher that predefined valued TH_{Warmup} that indicates the end of a warm up phase of the engine. When this condition is verified the method according this embodiment of the invention is stopped. Control of the EGR coolant temperature T_{EGRcool} may be refined by means of a closed loop control in order to keep the value of the coolant temperature T_{EGRcool} in the EGR cooler close 310 to the target value T_{EGRtgt}.

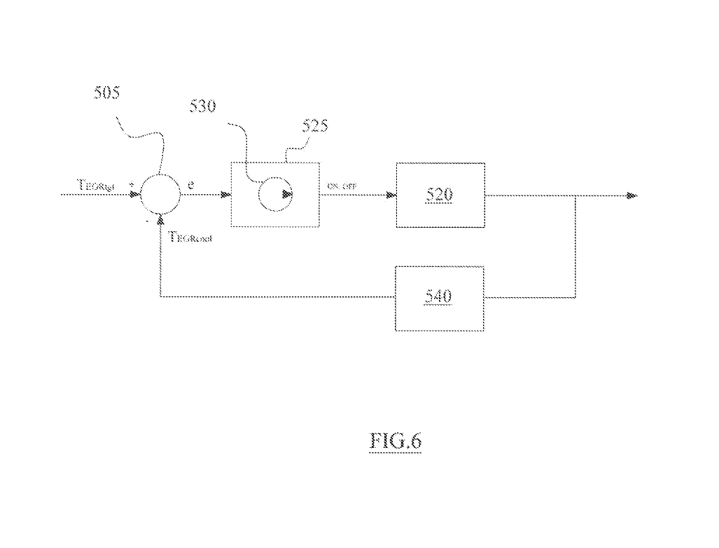

In this embodiment of the method, the ECU 450 may implement the closed-loop control strategy illustrated in the flowchart of FIG. 6. For each control cycle, this strategy provides for the ECU 450 to measure the actual value T_{EGRcool} of the EGR coolant temperature, for instance with the EGR coolant temperature sensor 540. The measured value T_{EGRcool} is then fed back and used to calculate a difference e (block 505) between the target value T_{EGRtgt} of the EGR coolant temperature and the actual value T_{EGRcool}. The difference e is sent to a controller 525, which decides the state of the EGR coolant pump to be ON or OFF according to the value of said difference e. If the difference between the target value T_{EGRtgt} and the measured value T_{EGRcool} is positive, then the pump is set on the ON state. If the difference between the target value T_{EGRtgt} and the measured value T_{EGRcool} is negative, then the pump is set on the OFF state.

Alternatively, in each embodiment of the method the EGR coolant temperature T_{EGRcool} can be estimated using a model based approach. The models may be mathematical and/or statistical models and may comprise an exhaust gas temperature feedback function or not.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1. A method of operating an Exhaust Gas Recirculation (EGR) system of a thermal energy source, the EGR system comprising an EGR circuit and an EGR cooler, the EGR cooler being connected in an heat exchanging relationship with an EGR coolant circuit that is equipped with an EGR coolant pump, the method comprising the steps of:
monitoring a parameter (T_{EGRcool}) representative of a temperature of the coolant in the EGR coolant circuit; and
operating the EGR coolant pump on the basis of the parameter (T_{EGRcool}) and of a target value thereof (T_{EGRtgt}).

2. A method according to claim 1, further comprising:
activating for a predetermined activation time (t_{ON}) the EGR coolant pump if the monitored value of the parameter (T_{EGRcool}) is higher than the target value (T_{EGRtgt}); and
deactivating for a predetermined deactivation time (t_{OFF}) the EGR coolant pump.

3. A method according to claim 1, wherein the activation state of the EGR coolant pump is adjusted with a closed-loop control strategy that uses as feedback the parameter value (T_{EGRcool}) to minimize a difference between the parameter value (T_{EGRcool}) and the target value (T_{EGRtgt}).

4. A method according to claim 1, further comprising:
monitoring a parameter (TH_{Load}) representative of a thermal load of the thermal energy source; and
bypassing the EGR cooler if the parameter (TH_{Load}) is lower than a first target value thereof (TH_{Cutoff}) representative of low thermal load conditions.

5. A method according to claim 2, further comprising:
repeating the activation and deactivation steps of the EGR coolant pump if the parameter (TH_{Load}) representative of a thermal load of the thermal energy source is higher than the first target value thereof (TH_{Cutoff}) and lower than a second target value thereof (TH_{Warmup}) representative of the end of a warm up phase of the thermal energy source.

6. A method according to claim 2, wherein the thermal energy source is an internal combustion engine.

7. A method according to claim 6, wherein the predetermined values of the activation time (t_{ON}) and of the deactivation time (t_{OFF}) of the EGR coolant pump are determined with an empirically determined map correlating different values of the activation time (t_{ON}) and of the deactivation time (t_{OFF}) to different values of engine speed, engine load, engine temperature, EGR gas flow in the EGR circuit, environmental temperature, and pressure.

8. A method according to claim 6, wherein the parameter (TH_{Load}) indicative of a thermal load is a function of engine temperature, engine speed, and engine torque.

9. An Exhaust Gas Recirculation (EGR) system of a thermal energy source, comprising:
an EGR circuit; and
an EGR cooler, connected in heat exchanging relationship with an EGR coolant circuit equipped with an EGR coolant pump,
wherein the EGR circuit and the EGR coolant circuit have portions which are adjacent to each other to form heat exchange area for the exhaust gas.

10. An apparatus for operating an Exhaust Gas Recirculation (EGR) system of an internal combustion engine, the EGR system comprising an EGR circuit and an EGR cooler, the EGR cooler being connected in a heat exchanging relationship with an EGR coolant circuit equipped with an EGR coolant pump, the apparatus comprising:
a monitor that is configured to monitor a parameter (T_{EGRcool}) representative of a temperature of the coolant in the EGR coolant circuit;
an operating device that is configured to operate the EGR coolant pump on the basis of the parameter (T_{EGRcool}) and of a target value thereof (T_{EGRtgt}).

11. An apparatus according to claim 10, wherein the monitory comprises a coolant temperature sensor.

12-15. (canceled)
